(19) United States
(12) Patent Application Publication
(10) Pub. No.: US 2026/0087177 A1
(43) Pub. Date: Mar. 26, 2026

(54) APPARATUS, A METHOD AND A NON-TRANSITORY MACHINE-READABLE STORAGE MEDIUM

(71) Applicants: Bin XING, Hillsboro, OR (US); Ned M. SMITH, Beaverton, OR (US); Vincent R. SCARLATA, Beaverton, OR (US)

(72) Inventors: Bin XING, Hillsboro, OR (US); Ned M. SMITH, Beaverton, OR (US); Vincent R. SCARLATA, Beaverton, OR (US)

(21) Appl. No.: 18/895,482

(22) Filed: Sep. 25, 2024

(51) Int. Cl. G06F 21/64; G06F 21/54; G06F 21/55

(52) U.S. Cl. CPC G06F 21/64; G06F 21/54; G06F 21/552

(57) ABSTRACT

It is provided an apparatus comprising interface circuitry, machine-readable instructions, and processing circuitry to execute the machine-readable instructions. The machine-readable instructions include instructions to record an entry into a virtual integrity register. The entry is based on a measurement of a module. The module is a part of a confidential computing environment. The machine-readable instructions further include instructions to load the module into a memory. The memory is accessible by the confidential computing environment. The machine-readable instructions further include instructions to record an entry of a log. The log comprises a load history. The entry comprises information about the loading of the module. The machine-readable instructions further include instructions to record an entry into an integrity measurement register. The entry being based on the recorded virtual integrity register entry.

### BACKGROUND

In the realm of Confidential Computing Environments (CCE), it may be important to securely manage and verify the integrity of the hardware and software components included in the CCE. Different components may be provided by different suppliers, as well as each component may consist of modules from different suppliers. The integrity of these components may be evaluated based on measurements of the components and reference values of the suppliers. However, the resources available to store these integrity measurements within the CCE may be limited. Therefore, it is desirable to improve the process of proving the integrity of these components and their parts, especially when they originate from different vendors.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a flowchart of an example of a method;

FIG. 3 illustrates software components of a CCE of different suppliers;

FIG. 4 illustrates a flowchart of a static module linking;

FIG. 5 illustrates the generation of artificially combined RIMs;

FIG. 6 illustrates an attestation workflow of a CCE 600 comprising a RIM;

FIG. 7 illustrates a workflow of CCE loading using a virtual integrity register (vIR);

FIG. 8 illustrates an example of a workload transaction integrity using vIR; and

FIG. 9 illustrates the hardening of a vIR using a level 2 virtual machine (L2VM).

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Bootstrap integrity in CCEs may be complicated by its ties to the supply chain of the modules of the CCE where suppliers both may release hardware/software images that make up an execution environment as well as product Reference Integrity Manifests (RIM) that may be consumed by attestation verifiers. If the supply chain is required to statically link different images, due to limitations in integrity registers and therefore in the limitation of the number of dynamically loaded images a CCE may support, RIM files must be artificially generated that have artificial suppliers. This may confuse attestation verifiers that expect RIM files to originate from their proper supplier (as not doing this is a pattern for a possible supply chain attack). Further, architecture specific measurements—both integrity registers (IR) and hash algorithms—may be architecture specific. Therefore, even the same software may have to have different measurements in different CCEs. For example, the same Linux kernel may be measured to a RTMR1 integrity register on Intel® TDX architecture but to PCR4 integrity register on secure encrypted virtualization (SEV) technology and a virtual trusted platform module (vTPM), respectively with potentially different hash algorithms. This may make it difficult to develop portable applications and provide RIMs to attestation verifiers. Furthermore, if multiple software modules may be loaded into the same CCE, it may be challenging to extract measurements of individual modules from the aggregated measurement and compare them against RIMs.

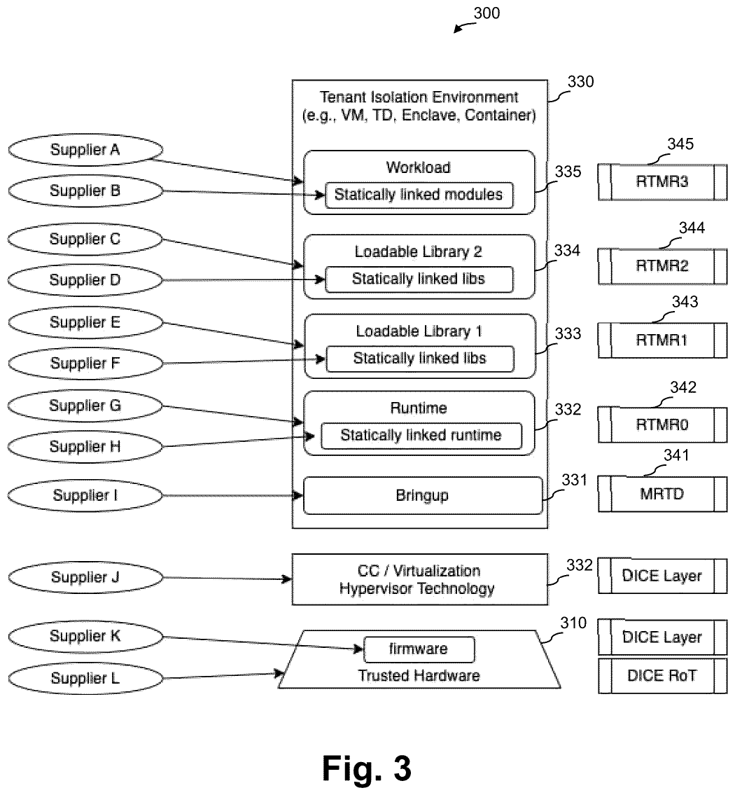

A CCE architecture may comprise a plurality of software components that may be protected by an (hardware) isolation environment (such as Intel® SGX, Intel® TDX, Intel® VTX, or other container isolation technology). A container image may comprise multiple software components (see FIG. 3 below) some of which may be statically linked. A CCE (such as Intel® TDX Trusted Domains (TD)) may support dynamic loading of CCE images. For example, an initial loader may load a CCE bring-up code into an execution environment (such as TD container). The measurement of the bring-up code may be recorded in an integrity register (such as measurement register of the trusted domain (MRTD)). The bring-up code may load a runtime image by measuring the runtime image and saving its measurement value in a first runtime integrity register (such as runtime measurement register 0 (RTMR0). Similarly, the bring-up code may measure a first library into a second runtime integrity register (such as RTMR1) and a second library into a third runtime integrity register (RTMR2). The workload may be loaded by bring-up code and a measurement stored in a fourth runtime integrity register (such as RTMR3). Since there are fixed number of runtime integrity register (for example four), there is a limit to the number of modules that may be loaded. However, the supply chain that contributed to the loaded images produces more modules than the number of loadable images. For example, suppliers A through supplier I may produce software modules that may have to be statically linked in various combinations that map to available registers (see FIG. 3). Therefore, the modules of several different suppliers are measured and recorded into the same runtime integrity register. This may cause problems when evaluating the measurements and comparing them against RIMs of the suppliers. In words, for example, the static linking may be done because there are not enough registers available to handle dynamically loaded components individually. This forces the system to or link the components into a single executable image during compile time to fit within the limited number of registers.

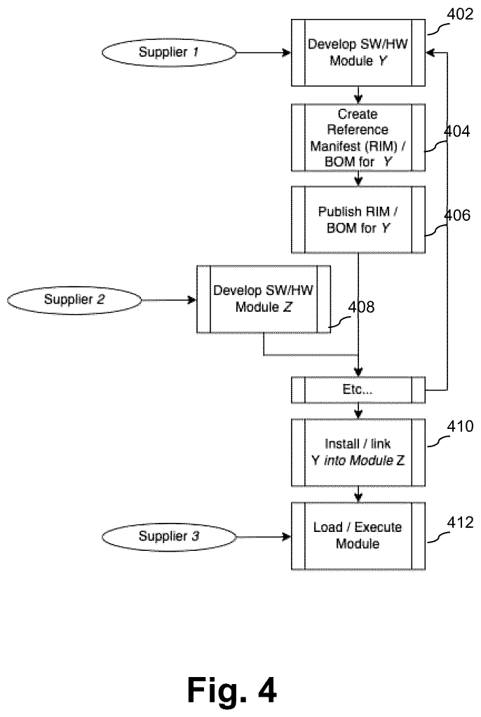

Therefore, in the supply chain ecosystems suppliers may cooperate forming a pipeline of software delivery capabilities that produces software images composed of other software images (see FIG. 4 below). That is, modules of different suppliers are linked into a linked module. However, respective suppliers may produce both a software image and reference integrity manifest (RIM) (also referred to as a bill-of-materials (BOM)) of their module. This RIM may contain a set of cryptographic digests, initialization settings or other values that can be used to check the integrity of a deployed image. For example, an executable image is distributed to customers through a supply chain and the RIM is published electronically for use by integrity checking services such as an attestation verifier.

Therefore, also for these linked modules corresponding RIMS comprise values of all the linked modules have to be generated. In other words, an artificial supply chain is needed to provide artificially combined RIMs for these the statically linked modules. This may result in suppliers needing to synchronize and coordinate construction of statically linked modules, and creation of a combined RIMs. For example, the combined RIM may be signed by a dominant supplier, while the subordinate supplier may become hidden to downstream consumers of RIMs such as attestation verifier.

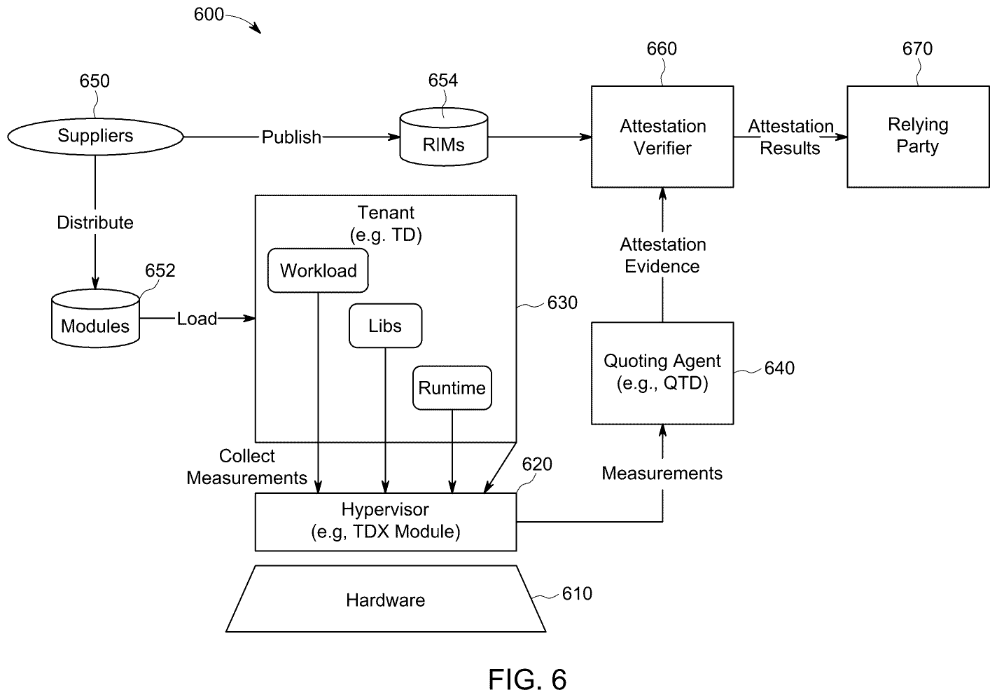

In an attestation workflow of a CCE collected measurements of modules of a tenant environment be compare the RIMS provided by the module supplier (see FIG. 6). As described above this may present challenges. For example, the measurements collected for the various components in the CCE may reflect a series of integrations of components applied as part of supply chain processes or at part of CCE load operations. Load operations may occur multiple times during the lifecycle CCE or the lifecycle of a workload. Because integrity registers are a fixed resource (e.g., RTMRs) the supply chain suppliers must coordinate the creating of RIMs and statically linked images constrained by the number of fixed resources. This may add to supply chain cost and friction. Integrity registers may be used to protect workload data integrity. For example, a workload may perform transaction on a database where each transaction commit results in an update to an integrity register. If a workload is limited to a single integrity register (e.g., RTMR3 in FIG. 3), transaction integrity may be either ignored or it may be layered on top of the workload integrity measurement using a common integrity register (i.e., RTMR3). However, attestation verifiers in this case have to subtract out the overloaded values before being able to appraise system integrity (see FIG. 6). Similarly, a workload transaction integrity may be hampered by overloaded integrity registers where the component integrity value may have to be subtracted out before processing a transaction log can proceed.

Previous approaches to this challenge may use Platform Configuration Registers (PCRs) within a Trusted Platform Module (TPM). In this case the boot code may measure the PCR with a digest of the loaded code. Some PCRs may be partitioned for specific use such as for pre-boot, OS boot, VMM/VM use, and application specific use. PCRs may be capped (prevented from further use) are left uncapped where other code may extend them for other usages. However, PCRs are only reset at system reset. If a workload uses a PCR for transaction integrity and the system must go through a reset cycle, the transaction integrity will be lost. Further, if the PCR is used for transaction integrity, the system integrity values may have to be subtracted out first. If the PCR is needed for attestation (system integrity evaluation), and it also extended with application specific content, the application specific content may have to be subtracted out. These constraints may make PCRs unsuitable for a broad spectrum of integrity use cases.

The technique proposed in this disclosure may enable CCEs containing workloads that perform a variety of use cases to use integrity registers as a per secured segment and/or module (for example workload specific) and architecture-neutral approach to system and usage-specific integrity. The technique proposed in this disclosure generates and provides a resource-unlimited virtual integrity register (vIR) for any given module and/or secure segment (for example per subdomain). For example, bring-up module operating during CCE initialization may be considered a secured segment and/or a module (for example a subdomain). A CCE runtime environment that responds to workload updates is a secured segment, and a workload that performs integrity checks over transactions it is processing may be yet another form of a secured segment and/or module domain. When a secured segment extends an vIR, the controlling layer may produce an entry into load log (also referred to as activity log) and extend a digest of the log into a runtime integrity register (for example a RTMR).

The proposed technique introduces further resettable integrity registers which allow sharing of limited number of integrity register resources. Upon integrity register reset, a report may be generated and signed such that the state of the integrity register is integrity protected and preserved in a history file. The integrity register may be cleared and used by another secured segment, module and/or CCE. The combination of vIRs and resettable integrity registers may be applied to achieve both integrity, scalability, and performance optimization.

For example, static integrity registers may attest to secured segments states, while runtime integrity registers may measure configurations or loaded code. Entities verifying a quote/attestation evidence (such as a TDX quote), like quoting environment (such as QTD) or attestation services, may verify and replay the load log to recalculate vIR entries for all secured segments/modules. For example, an Intel® Trust Authority (ITA) attestation service may verify TDX quotes, replays load logs (such as RTMR logs), and recalculates vIR entries. Each independent software vendor (ISV) may independently provide reference values in RIMs for their secured segment/module within the CCE. Attestation services may assess the controlling layer's trustworthiness and all secured segments using reference values/RIMs from respective ISVs. For example, it signs recalculated virtual measurements for consumption by other attestation services or the relying party directly.

In some examples, a concise reference integrity manifest (CoRIM) defines a measurement type integrity-register which may be a list of labeled digests. It may be used to capture dynamic/runtime measurements in a standardized format. The digest of the vIR entries may be integrity protected using an integrity register (such as an RTMR). The vIR may also serve as a log where the digest of the load and or update activity is also added to the IR. The module may be identified by its object identifier (OID) which may be modeled using CoRIM and/or concise module identifier (CoMID). Each secured segment/module/layer may produce its own vIR structure. If a higher layer wants to verify a lower layer, it may enter the results into another vIR entry with the result e.g., result-digest=hash (integrity register-of-layer, verified, verifier-key-id). This way both layered attestation evidence as well as layered verification may flow simultaneously as needed.

The above described technique may enable that a limited number of resettable integrity register resources may be effectively shared across multiple secured segments/modules within a CCE or between multiple CCEs. Further, the above described technique may allow virtual integrity registers to be created within a CCE secured segment/module to scale with the number and performance requirements of the secured segment/module/workload requirements. Further, the above described technique may allow software updates to the CCE may be applied dynamically where an integrity report is created that is integrity register specific. That is, if a single component is updated, a corresponding integrity report may be generated which is containing attestation evidence that documents the change. Further, the above described technique may allow resettable integrity registers to decouple the actions of a first user from the actions of a second user without requiring system/CCE to reset. Further, the above described technique may allow the integrity register reports to be directed to the entity that is most appropriately tasked to manage the report. For example, the attestation reports involving a resettable integrity register and its associated vIR log, may be maintained by a quoting environment while integrity of an application specific usage (e.g., transaction processing) may be maintained by the workload.

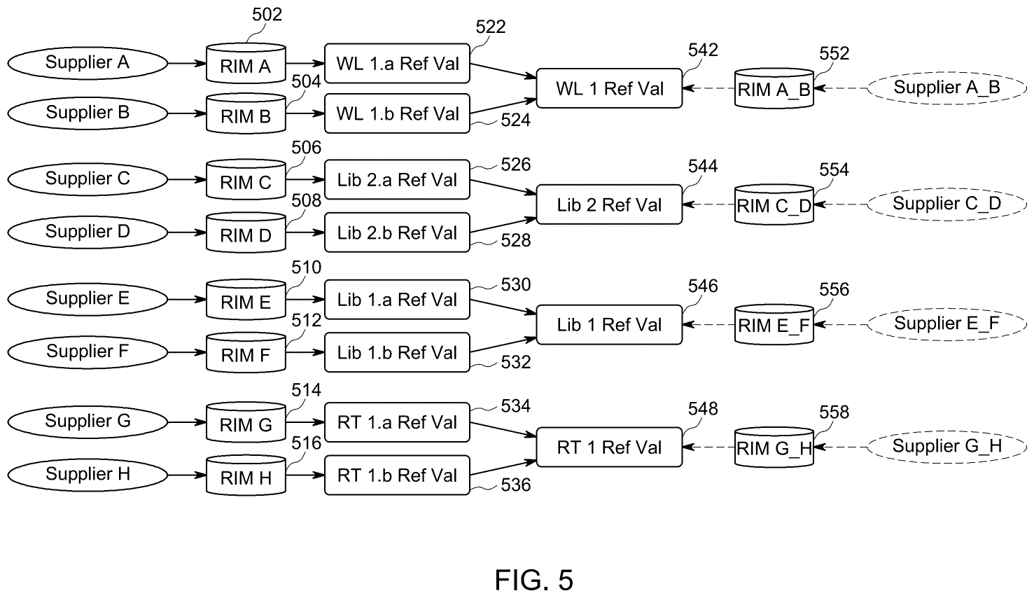

In other words, the disclosed technique may define a virtual integrity register and virtual measurement framework that allows software defined measurements. That is software may be allowed to define vIR entries of arbitrary names and hash algorithms, for measuring the software image as well as any dynamically loaded code/data/config. Its ISV only needs to provide one architecture independent RIM. Further, disclosed technique may define/group vIRs (as attestation evidence) per secured segment/module, which represents the runtime environment of a module. This may allow attestation verifiers to compare claims of secured segments/modules against respective RIMs. Further, the disclosed technique may create concise software bills-of-material (SBOM) (see FIG. 5).

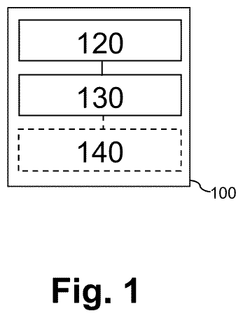

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 130 is configured to record an entry into a virtual integrity register. The entry being based on a measurement of a module. The module is a part of a confidential computing environment.

A CCE architecture may comprise a combination of specialized hardware and software components designed to protect data and computations from unauthorized access and tampering within a computer system. The CCE architecture may provide secure processing circuitry, which is responsible for executing sensitive workloads in an isolated environment. Additionally, the CCE architecture may provide secure memory, such as a protected region of the computer system's RAM, where sensitive data can be stored during computation. To further safeguard this data, the CCE architecture may provide memory encryption, ensuring that the contents of the system memory are protected even if physical access to the memory is obtained. For example, the CCE architecture may support I/O isolation and secure input/output operations, preventing data leakage during communication between the processing circuitry and peripheral devices. In some examples, the CCE architecture may provide secure storage capabilities of the computer system, such as a secure partition within the system's main storage, dedicated to storing cryptographic keys, sensitive configuration data. This secure storage ensures that critical data remains protected even when at rest. In some examples, the CCE may also comprise separate secure storage components, such as a tamper-resistant storage chip, like an integrity measurement register, to securely store measurements of the CCE and/or critical data associated with the CCE's operation. A host may generate one or more instances of CCEs based on the CCE architecture. The instances of the CCE architecture may be referred to as a CCE (also referred to as a Trusted Execution Environment). The CCE uses its components to enable the secure and isolated execution of workloads. A workload executed in the CCE may include a set of applications, tasks, or processes that are actively managed and protected by these secure hardware components. This includes computational activities that utilize the CCE's resources, including CPU, memory, and storage, to perform their operations. Such activities may involve running applications, processing sensitive data, performing calculations, and managing tasks that require a high level of security and confidentiality. The CCE ensures that these workloads are protected from unauthorized access and tampering by leveraging hardware-based security features and cryptographic measures, thereby maintaining the integrity and confidentiality of the data and processes throughout their execution.

The CCE may comprise one or more hierarchical layered environments, each specifically designed to perform distinct computing functions within the CCE. These environments may be categorized based on their roles and responsibilities, ensuring a structured and secure computing framework. An environment of the CCE may comprise one or more modules, each responsible for specific tasks or operations within that environment. A module of an environment of the CCE may be configured to execute particular functions such as initializing the environment, running applications, managing data, performing cryptographic operations, or ensuring the integrity of the environment and its processes. These modules work together within their respective environments to maintain the security, integrity, and confidentiality of the CCE as a whole. For example, there may be one or more foundational environments of the CCE responsible for core security functions, such as the Root of Trust (RoT). The RoT may be a hardware-based security component that provides a secure and immutable trust anchor for the layers above it. The foundational security provides the essential security mechanisms and trust anchors upon which the entire framework is built. The foundational security framework provides the base upon which the entire CCE's security relies. One example of a foundational security framework is the Device Identifier Composition Engine (DICE) specification. DICE is a hardware-based security mechanism that generates unique cryptographic identities and keys based on the initial measurement of a device's hardware and firmware state during boot. DICE comprises a process that derives cryptographic keys at each stage of the boot process. The keys derived based on DICE may be used to derive various cryptographic keys, including firmware keys and quoting keys, which create a chain of trust through layered identities and attestation. DICE may be defined in the specification “DICE Attestation Architecture” by the Trusted Computing Group, Version 1.1, Revision 0.18, Jan. 6, 2024. Further, the foundational environment of the CCE may comprise a trusted platform manager (also referred to as a Trusted Platform Module, or TPM). The trusted platform manager may record measurements of the CCE into an integrity register and manage cryptographic keys to sign measurements for internal verification. The trusted platform manager ensures that the system starts from a trusted state, forming the foundational security upon which the CCE operates.

Another environment within the CCE may be the quoting environment (QE), also known as the quoting agent, which is responsible for gathering, formatting, reformatting, and signing measurements and generating attestation evidence (also referred to as quotes) from other layered environments within the CCE. The QE may comprise modules responsible for handling cryptographic operations, such as formatting and signing the integrity measurements collected from higher layers. For instance, the QE may receive measurements from an execution environment and format or sign them with a cryptographic key to produce attestation evidence. This attestation evidence may be consolidated and structured in a way that can be verified by an external attestation verifier. For example, the CCE may comprise an execution environment (such as a tenant environment (TE)) and a service environment (such as a migration environment (ME)). The execution environment may be a secure, isolated execution space dedicated to running a tenant's (user's) applications, data, and workloads.

In some examples, the module may be least one of a runtime environment, a library and a workload. In some examples, module is executed in an execution environment of the CCE. For example, the execution environment may comprise a runtime environment module, which might be an operating system layer that provides essential services for application execution. The execution environment may comprise library modules that offer common functionality needed by the tenant's applications. The execution environment may comprise a workload, for example the tenant's application code that performs specific tasks. The execution environment may further comprise a bring-up code module, which may be responsible for initializing and loading the components of the execution environment, and for measuring the integrity of the execution environment and its modules. The bring-up code module may further be configured to secure memory regions necessary for their operation, thus establishing a secure execution environment within the CCE. The execution environment may be layered on top of the foundational hardware and firmware components, which provide basic secure enclave and isolated execution capabilities, ensuring that the tenant's assets are isolated from other tenants and protected from the underlying system.

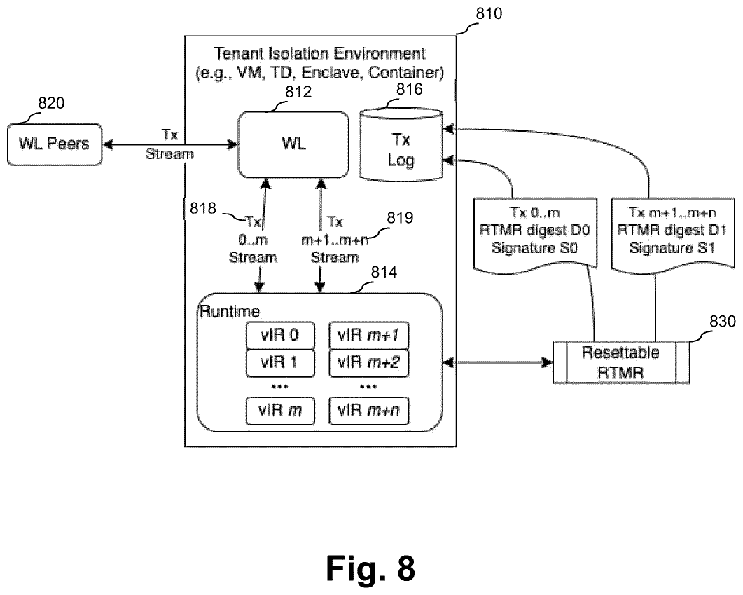

In some examples, the module is a workload performing one or more transactions with another party. The workload module may be responsible for executing and managing tasks that involve secure interactions between the CCE and an external entity, such as another system, service, or user. Transactions may include financial exchanges, data processing tasks, or any operation that requires secure communication and processing between the CCE and the other party. The integrity of these transactions may be ensured by recording them into entries of the virtual Integrity Register (vIR). Each transaction may be monitored and securely logged within the vIR, providing a tamper-evident record that can be used for verification and attestation purposes. This ensures that every transaction conducted by the module is accurately tracked and can be validated to maintain the overall security and trustworthiness of the CCE (see also FIG. 8 below).

The hierarchically layered environments may be structured such that a lower layer may support and attest to the integrity of a layer above it, ensuring a continuous chain of trust throughout the CCE. For example, a lower layered environment of the CCE may receive a measurement from the environment layered above and sign it with its private key. In some examples, a measurement from a higher layer is signed by a lower layer to maintain a continuous chain of trust. This may be referred to as a trust dependency between the higher layer and the lower layer. For example, the measurement of a higher layer is signed with the private key of a lower layer, and the public key of the private-public key pair of the higher layer may also be signed with the private key of the lower layer. This ensures that the public key, when used to verify the measurement, is authenticated by the lower layer's signature. A private-public key pair, also known as asymmetric cryptography or public-key cryptography, is a cryptographic tool used for secure communication and authentication. The private key is kept secret and is used to sign data, creating a digital signature that verifies the data's integrity and origin. The corresponding public key is shared openly and is used to verify the digital signature created by the private key, ensuring that the data has not been tampered with and confirming the identity of the sender. This pair enables secure data exchange and authentication without needing to share the private key, thus maintaining security.

A measurement of a component of the CCE represents the state of a software or hardware component involved with a layered environment of the CCE at a specific point in time. For example, a measurement may be a cryptographic digest that represents the state of the entire CCE, a specific environment within the CCE, a module within an environment, or any combination thereof at that moment. These measurements are crucial for verifying the integrity of the CCE components, ensuring they have not been altered or tampered with. A measurement may be used in an attestation evidence to validate the integrity of a CCE component. This measurement typically involves generating a cryptographic hash of the component, which may include the binary executable code, configuration data, and/or initial state data of the software or hardware component. The hash is produced by reading the raw binary data of the system's software components and processing it through a cryptographic hash function (e.g., SHA-256) to create a fixed-size hash value that uniquely represents the exact state of the component at that specific point in time.

A measurement may be taken, for example, when a component or module is initially loaded into the memory of the CCE (often referred to as a static or load-time measurement). In this example, the binary image of the component or module, including its code and data, is hashed to capture its state as it enters the CCE. This load-time or static measurement serves as a baseline, ensuring that the module begins in a known, secure state. However, during runtime, the components or modules of the CCE (including the workload) may undergo changes, such as updates or the loading of additional code or configurations or them like. For example, a measurement of the component may be taken dynamically during runtime (referred to as a runtime or dynamic measurement). The dynamic measurement captures the current state of the component, reflecting the changes that have occurred since the initial load. These dynamic measurements serve as ongoing checks to ensure the component's integrity throughout its operational lifecycle. Any taken measurement may then be recorded into a virtual or hardware integrity register, as described below.

A secured segment of a CCE may be an isolated and specifically defined part of the CCE that is dedicated to performing a particular task and/or function. For example, a secured segment may comprise one or more modules, environments and/or components of the CCE. A secured segment operates within its own defined boundaries, with access only to the components and resources necessary for its specific role. For example, a secured segment of the CCE may be isolated from other segments of the CCE in terms of memory access and/or execution. A secure segment may be a focused environment, such as the execution environment or parts thereof, each serving a distinct purpose within the broader CCE framework. Secured segments may be protected by strict security measures, including cryptographic techniques and access controls, ensuring that the integrity and confidentiality of their components are maintained. By isolating and securing these segments, the CCE can effectively manage and verify the security of its various components, thereby maintaining the overall integrity and trustworthiness of the environment. For example, in case that the CCE is an Intel® TDX, the secured segment may be a subdomain of a trusted domain.

The virtual integrity register (vIR) may be a software-defined register for storing measurements of components of the CCE. The vIR may be a structured storage space, for example organized as a sequence of entries, where each entry contains specific data. For example, there may be a separate entry into the vIR for each module of the CCE. In another example, there may be a separate entry into the vIR for each secure segment of the CCE (in some examples, a module may correspond to one secure segment). Recording a new entry in into the vIR may comprise adding new information, such as the measurement of the module into this pre-existing structure. For example, each entry of the vIR is stored in a defined format, allowing the register to maintain an organized record of all measurements or events, which can later be accessed or verified to ensure the integrity and security of the system. The vIR is not bound by the limitations of physical hardware, as a hardware integrity register is. The vIR may dynamically allocate space within the secure memory accessible by the CCE to accommodate measurements. Therefore, the vIR may be only limited by the available secure memory of the CCE and not by the size constraints of hardware integrity registers. The secure memory accessible by the CCE may be, for example, a protected region of the RAM of the computer system hosting the CCE, isolated from the rest of the system. This ensures that the data stored within the vIR remains secure and inaccessible to unauthorized processes. For example, the generation of attestation evidence (also referred to as quotes) may be based on these recorded measurements, which provide proof of the integrity of the modules and/or secured segments.

In some examples, the processing circuitry 130 may be configured to generate the virtual Integrity Register. The vIR may reside in a memory accessible by the CCE, such as a protected region of the RAM within the computer system hosting the CCE. The generation of the vIR may involve dynamically allocating space within this secure memory, which is isolated from the rest of the system to ensure security and integrity. This process may include initializing the vIR as a structured data area, specifically designed to store cryptographic measurements of the modules and/or secured segments of the CCE.

The processing circuitry 130 is further configured to load the module into a memory. The memory is accessible by the CCE. Loading of the module may comprise placing the module's binary code and data into the memory accessible by the CCE. The memory accessible by the CCE may be a protected region of the RAM within the computer system hosting the CCE. For example, this may be the same or a different protected area of the RAM where vIR is stored. This memory may be specifically allocated for use by the CCE to ensure that the module operates within a protected environment. The secure memory is designed to prevent unauthorized access and tampering, ensuring that only trusted processes within the CCE can interact with the loaded module.

The processing circuitry 130 is further configured to load the module into a memory that is accessible by the CCE. Loading the module may involve placing the module's binary code and data into this designated memory space, which is typically a protected region of the RAM within the computer system hosting the CCE. This secure memory area may be the same or different from the region where the vIR is stored. The memory area may be isolated from the rest of the system to maintain security. The purpose of using this protected memory is to ensure that the module operates within a secure environment, where it is shielded from unauthorized access and tampering. Only trusted processes within the CCE can interact with the module in this memory, ensuring that its execution remains secure, and that the system's overall integrity is preserved

In some examples, the measurement on which the entry to the vIR is based may be obtained before loading the module into the memory. This may be considered a static or load-time measurement as described above. This measurement may capture the module's state as it is being loaded, serving as a secure baseline by hashing its binary image, including code and data, to ensure it starts in a known, unaltered state. In some examples the measurement on which the entry to the vIR is based may be obtained after loading the module into the memory. This may be considered a runtime or dynamic measurement as described above. This measurement may capture the modules current state and reflecting any changes, updates, or additional configurations that occur during operation.

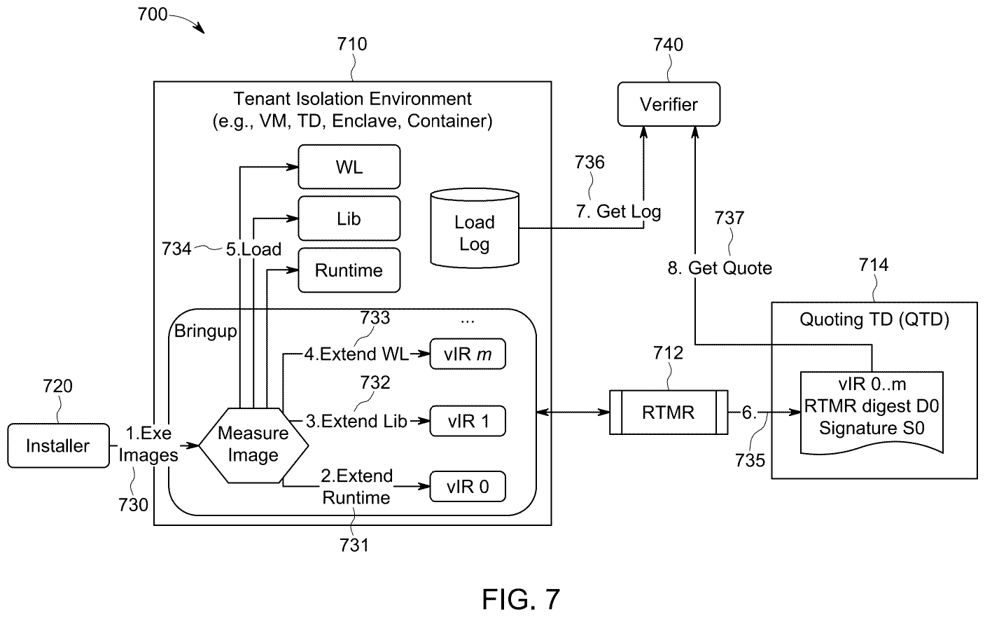

The processing circuitry 130 is further configured to record an entry into a log (also referred to as load log or activity log). The log comprises a load history and/or alteration history of modules, for example during the lifecycle of the CCE (e.g., the CCE instance). In some examples, an installer (see installer 720 in FIG. 7) may create an initial bringup module which may be the first module which may also be written to the load log by the installer. The entry comprises information about the loading of the module. The load log may be a structured data record that captures the detailed history of modules as they are loaded into the CCE. For example, the load log may capture the history of all modules that were loaded during the lifecycle of the workload. For example, the load log may capture the history of all modules that were loaded during the lifecycle CCE (that is the CCE instance). The log may be organized as a sequential list or a series of entries, each recording information about a module's loading process, thereby forming a comprehensive load history. Recording a new entry in the load log may comprise capturing information about the loaded module and any relevant context and writing this information into the log. The log may be stored in secure memory, such as a protected region of RAM, ensuring that it is accessible only to authorized processes within the CCE and protected from unauthorized access or tampering. In some examples, information about the loading of the module and/or information about previously loaded modules may comprise at least one of the following: a timestamp of the loading of the module, a position within a sequence of modules that are loaded, and an identifier of the module. A timestamp of the loading of the module may indicate the exact time at which the module was loaded into the CCE, providing a chronological reference for the load event. A position in the sequence of modules that are loaded may reflect the order in which the module was loaded relative to other modules, helping to establish the loading sequence and dependencies between modules. An identifier of the module may be a unique value that distinguishes the module from others, ensuring precise tracking and verification. For example, the module identifier may be a cryptographic digest of the module's firmware, which also may serve as an attested value. This attested value can be further augmented by an endorsement statement from the vendor of the module, providing additional context such as the module's version number, quality metrics applied during manufacturing, or the taxonomies and ontologies to which the module belongs

In some examples, a loaded image may be patched (without unloading/reloading the image). For example, if the image is patched, then the log may be also updated (for example by the installer that applied the patch) to reflect application of the patch such that no change that is applied to the CCE may go unaccounted for. In some examples, the log may also comprise deltas of the trusted layers underneath.

The processing circuitry 130 is further configured to record an entry into an integrity measurement register. The entry is based on the recorded virtual integrity register entry. The integrity measurement register (IMR) is a secure storage component within the CCE that is designed to values based on measurements of the CCE. For example, the IMR is a non-volatile memory that is physically separated from other memory and storage accessible by the confidential computing environment ensuring a higher level of security and tamper resistance. For example, the IMR may be a runtime integrity measurement register (RTMR).

Recording an entry into the IMR may comprise generating a new entry that comprises data that is based on the recorded entry of the vIR. For example, the data that is based on the recorded entry of the vIR may comprise a cryptographic hash (also referred to as digest) based on the recorded entry of the vIR. In another example, recording an entry into the IMR may involve adding data based on the recorded entry of the vIR to an existing entry in the IMR without erasing the information of the already existing entry. For instance, the data based on the vIR entry may be a cryptographic hash or digest that is concatenated with the data of the existing IMR entry. The concatenated data may then be hashed, and the resulting hash may replace the former entry in the IMR (this process may be referred to as extending the new data into the IMR). This extension mechanism may allow the IMR to maintain a continuous, tamper-evident record of the CCE's integrity over time.

In some examples, the processing circuitry 130 is further configured to transmit attestation evidence, which is based on the one or more recorded entries of the integrity measurement register, together with the load log to an attestation verifier. The attestation verifier is configured to evaluate the integrity of one or more modules, components, or secured segments of the CCE on whose measurements the one or more entries of the IMR are based. For example, the attestation verifier may use the load log to reconstruct the load sequence and the one or more measurements as stored in the entry of the vIR. The attestation verifier may then determine a digest of the reconstructed vIR entry and compare it to the recorded entry in the IMR. If they match, the load log accurately reflects the system's state. Once this match is confirmed, the attestation verifier may compare the IMR digest entry against the expected value provided in a Reference Integrity Manifest (RIM). This final comparison ensures that the one or more modules, components, or secured segments of the CCE are operating in an untampered and expected state, as defined by the RIM, thereby confirming the integrity of these elements.

The described technique offers a robust and scalable approach to maintaining the integrity of a CCE and/or its components by integrating a vIR with hardware-based integrity registers such as the IMR. By recording entries into a vIR based on the measurements of individual modules or secured segments, the integrity of components within the CCE can be dynamically tracked and managed, ensuring precise and scalable monitoring tailored to specific performance and security requirements without being constrained by storage capacity limitations of the IMR. By linking the vIR entries to the IMR efficient sharing of limited hardware resources across multiple modules or even multiple CCE instances is possible while ensuring that vIR entries remain IMR-secured. This linkage maintains continuous, tamper-evident integrity across various use cases, from system-level security to application-specific processes like transaction processing. The vIR can be dynamically scaled according to the number and performance requirements of the modules or workloads, allowing updates to be measured and recorded in real-time. The attestation verifier, in turn, uses the load log to reconstruct the load sequence and vIR entries, generating a digest that is compared to the IMR. If these match, the load log is confirmed as an accurate depiction of the loading events.

As described above, one or more entries of the vIR may be hashed to a generate a digest which is then stored into a IMR entry or an IMR entry is extend by this digest. Thereby, the vIR entries are IMR-secured. Furthermore, based on one or more IMR entries an attestation evidence is generated. The attestation evidence may comprise one or more IMR entries and a signature of the one or more IMR entries. In some examples, processing circuitry 130 is further configured to generate a digest of the one or more entries of the IMR. The attestation evidence in this case may then comprise the digest of the one or more IMR entries and the corresponding signature. In some examples, the processing circuitry is further configured to transmit the signed one or more entries of the IMR (for example as part of attestation evidence) and the load log to an attestation verifier.

In some examples, the processing circuitry 130 may be further configured to sign the one or more entries of the IMR with a cryptographic key. This yields a signature of the one or more IMR entries. Signing an entry of the IMR, or a digest of an entry of the IMR, may comprise generating a digital signature by encrypting entry of the IMR, or a digest of an entry with a private key of a private-public key pair, thereby ensuring the authenticity and integrity of the measurement. For example, generating a digital signature may comprise creating a cryptographic hash of the measurement (the component's state) and then signing this hash with a private key to produce a digital signature, ensuring the integrity and authenticity of the measurement. The verifier may use the corresponding public key to authenticate the signature. If multiple entries of the IMR are involved, these entries may first be concatenated and hashed. The resulting hash can then be treated as a single entry, which may be processed as described above.

In some examples, the processing circuitry 130 is further configured to store a report IRM based on one or more entries of the IMR in a memory accessible by the CCE. The IRM report may include some or all of the IMR entries and/or their corresponding signatures, which authenticate these entries. In some examples, the IRM report may comprise the root of a hash tree constructed from some or all of the IMR entries, where in some examples the root may be digitally signed. The memory accessible by the CCE could be a protected region of the RAM within the computer system hosting the CCE, for example the same or a different protected area of RAM where the vIR is stored. This memory may be specifically allocated for use by the CCE to ensure that the report is securely stored and accessed within a protected environment, designed to prevent unauthorized access and tampering. This secure memory setup ensures that only trusted processes within the CCE can load and/or transmit the stored report. The report may be used later for attestation or verification purposes, such as generating attestation evidence that can be transmitted to an attestation verifier upon request. Storing the report in memory accessible by the CCE allows the system to maintain a verifiable record of the IMR's contents, which can be referenced or transmitted to confirm the integrity of the CCE's state. For example, the report may be generated and stored before the IMR is reset, as it may be needed for verifying other vIR entries, such as those related to another module or secured segment.

In some examples, the processing circuitry 130 may be configured to reset the IMR. Resetting the IMR may comprise erasing some or all of its entries and preparing it to record new data based on entries from the vIR. For instance, the IMR may be reset after a report containing its entries has been stored in memory accessible by the CCE as described above. For example, the resetting process may be triggered when a new workload is started in the CCE or when a new instance of the CCE is initiated on the host system. For example, the IMR may be reset when a new module or secured segment is measured into the vIR, which is then extended into the IMR. This technique, may be referred to as a resettable IMR (in the case of a RTMR, as a resettable RTMR (R.RTMR)).

For example, the resettable IMR may allow the system to decouple the actions of different users without necessitating a CCE reset. The IMR reports may be directed to a quoting environment for system-level reports, while application-specific integrity, such as for transaction processing, may be managed directly by the workload itself.

In some examples, the recorded entry in the IMR may be based on a plurality of vIR entries. For example, extending an entry based on first entry of the vIR by extending it with one or more subsequent entries if the vIR. That is the entry in the IMR may be extended as described above by concatenating and hashing the new data with the existing IMR entry. In another example, a plurality of vIR entries may be combined into a single digest, and this digest may then be stored in a new entry of the IMR or used to extend an already existing IMR entry.

In some examples, the processing circuitry 130 is further configured to generate a hash tree based on a plurality of entries of the vIR. A hash tree (also referred to as Merkle Tree) is a cryptographic data structure that combines individual data hashes into a tree-like structure, where the root hash represents the integrity of all the data within the tree. For example, a plurality of entries of the vIR are hashed into a hash tree. That is, each of the vIR entries is individually hashed, and these hashes are then combined into a hash tree structure. The final hash of the tree, known as the root hash, provides a single, compact representation of the integrity of all the vIR entries. This root hash can be used to efficiently verify the integrity of the individual entries, ensuring that the plurality of vIR entries remains secure and tamper evident. The root hash of this hash tree may be recorded into the IMR. For example, the root hash of the hash tree may be signed.

As described above, in some examples, the load log may be stored in secure memory, such as a protected region of RAM, ensuring that it is accessible only to authorized processes within the CCE and protected from unauthorized access or tampering. In this case the integrity of the log may be indirectly verified by comparing the reconstructed measurements, derived from the sequence of modules loads detailed in the log, with the digest stored in the IMR. The load log records the process of module loading and their corresponding measurements. During verification, the verifier uses the load log to recreate the expected measurements and then generates a digest from these. This recreated digest is then compared to the digest already stored in the IMR. If they match, it confirms that the load log accurately reflects the system's state and hasn't been tampered with. If they don't match, it indicates possible tampering, as the load log would not accurately reflect the measurements stored in the IMR.

In some examples, the processing circuitry 130 is further configured to generate a digest of the load log. The processing circuitry 130 may be further configured to write the digest into the IMR. The IMR may ensuring that the load log's integrity is securely recorded and can be verified later. This provides a tamper-evident, compact representation of the load log, allowing for efficient and reliable integrity verification of the CCE's state without needing to store or process the entire log during attestation. During attestation in this case, the system provides the load log and the stored digest of the load log to the attestation verifier, who reconstructs the load log and generates a corresponding digest. The verifier then compares this newly generated digest with the one stored in the IMR. If the digests match, it confirms the integrity and authenticity of the load log, ensuring that the CCE's state has not been tampered with. This method provides a secure and efficient way to verify the integrity of the CCE using a compact digest rather than processing the entire load log

In some examples, the apparatus 100 may be at least one of the following or may be at least part of one of the following: a cloud server, an edge server and a user device. In cloud computing, the server carrying out technique of apparatus 100 may be cloud server. The cloud server may be designed to handle large-scale workloads with robust processing capabilities, high availability, and scalability. The cloud server may be optimized for managing a vast number of virtualized instances, ensuring that the workloads they host are securely isolated and efficiently managed. In an edge computing scenario, the apparatus 100 may be implemented on an edge server. The edge server may be closer to the end-user and designed for low-latency processing, making it ideal for tasks that require real-time data processing and quick response times. The edge server may execute the technique of apparatus 100 to manage and attest to the integrity of workloads running in environments with limited resources but with high requirements for performance and responsiveness. In an edge-to-cloud infrastructure, the specific entity executing the technique of apparatus 100 (cloud server or edge server or a user agent) may depend on the workload's requirements and the desired performance characteristics. The edge server may be the one carrying out the steps if the workload needs low-latency access and is sensitive to the proximity of data processing, such as in IoT applications or real-time analytics. The cloud server may be better suited for tasks that require significant computational resources, centralized data management, or long-term storage. The apparatus 100 may be designed to be adaptable, allowing the workload to be scheduled on any node across the edge-to-cloud spectrum based on factors like performance, latency, and availability. This flexibility ensures that the apparatus 100 can optimize workload placement, whether it's in a high-performance cloud environment, a responsive edge server, or another suitable node in the infrastructure.

Further details and aspects are mentioned in connection with the examples described below. The example shown in FIG. 1 may include one or more optional additional features corresponding to one or more aspects mentioned in connection with the proposed concept or one or more examples described below (e.g., FIGS. 1-9) .

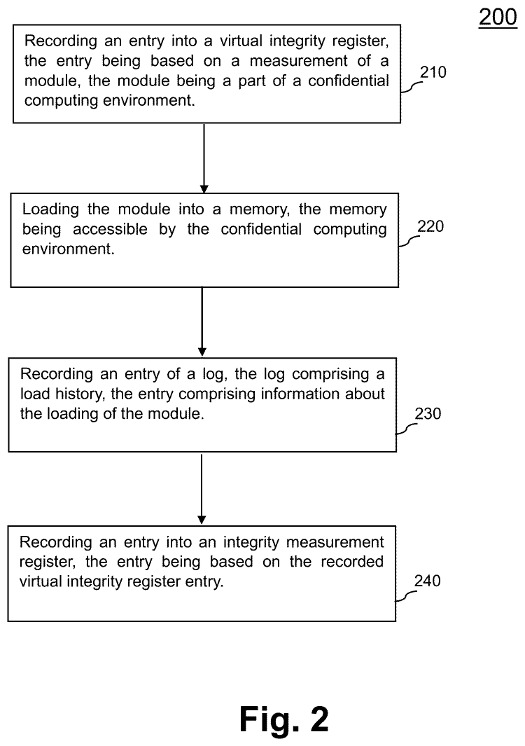

FIG. 2 illustrates a flowchart of an example of a method 200. The method 200 may, for instance, be performed by an apparatus as described herein, such as apparatus 100. The method 200 comprises recording 210 an entry into a virtual integrity register. The entry is based on a measurement of a module. The module is a part of a confidential computing environment. The method 200 further comprises loading 220 the module into a memory. The memory is accessible by the CCE. The method further comprises recording 230 an entry of a log. The log comprises a load history. The entry comprises information about the loading of the module. The method further comprises recording 240 an entry into an integrity measurement register. The entry is based on the recorded virtual integrity register entry.

More details and aspects of the method 200 are explained in connection with the proposed technique or one or more examples described above (e.g., with reference to FIG. 1), or below. The method 200 may comprise one or more additional optional features corresponding to one or more aspects of the proposed technique, or one or more examples described above (e.g., FIG. 1) or below (e.g., FIGS. 3-9).

### Further Examples

FIGS. 3 to 6 may describe a challenge that arises for example due to limited integrity register resource in a CCE. FIGS. 7 to 9 may describe further examples, of the technique proposed in this disclosure.

FIG. 3 illustrates software components of a CCE 300 of different suppliers. The CCE 300 comprises a foundational environment 310, a resource manager (for example a hypervisor) 320 and a tenant environment 330. The tenant environment comprises a bring-up code 331, a runtime environment 332, a first library 333, a second library 334 and a workload 335. Suppliers A and B produced software modules that are statically linked in the workload. Suppliers C and D produced software modules that are statically linked in second library 334. Suppliers E and F produced software modules that are statically linked in first library 334. Suppliers G and H produced software modules that are statically linked in runtime environment 332. Supplier I produced software modules of the bring-up code 334. A measurement of the bring-up code 331 is recorded in a MRTD register 341. The bring-up code measures and records the runtime environment 332 into the runtime integrity register RTMR0 register 342. The bring-up code measures and records the first library 333 into the runtime integrity register RTMR1 register 343. The bring-up code measures and records the second library 334 into the runtime integrity register RTMR2 register 344. The bring-up code measures and records the workload 335 into the runtime integrity register RTMR3 register 345. Since there only 4 of runtime integrity register (for example four), there is a limit to the number of modules that may be loaded.

FIG. 4 illustrates a flowchart of a static module linking. In step 402 supplier 1 develops software or hardware module Y. In step 404 supplier 1 creates a RIM of the module Y. In step 406 supplier 1 publishes the RIM of the module Y for use by integrity checking services such as an attestation verifier. In step 408 supplier 2 develops software or hardware module Z. In step 410 module Y and module Z are linked into a linked module. In step 412 supplier 3 loads and/or executes the linked module.

FIG. 5 illustrates the generation of artificially combined RIMs. Supplier A generates RIM A 502 that comprises a first workload reference value 522. Supplier B generates RIM B 504 that comprises a second workload reference value 524. The first workload reference value 522 and the second workload reference value 524 are combined into a combined workload reference value 542. The combined workload reference value 542 is use as a combined RIM A_B 552. Supplier C generates RIM C 506 that comprises a first library two reference value 526. Supplier D generates RIM D 508 that comprises a second library two reference value 528. The first library two reference value 526 and the second library two reference value 528 are combined into a combined library two reference value 544. The combined library two reference value 544 is use as a combined RIM C_D 554. Supplier E generates RIM E 510 that comprises a first library one reference value 530. Supplier F generates RIM F 512 that comprises a second library one reference value 532. The first library one reference value 530 and the second library one reference value 532 are combined into a combined library one reference value 546. The combined library one reference value 546 is use as a combined RIM E_F 556. Supplier G generates RIM G 514 that comprises a first runtime environment reference value 534. Supplier H generates RIM H 516 that comprises a second runtime environment reference value 536. The first runtime environment reference value 534 and the second runtime environment reference value 536 are combined into a combined runtime environment reference value 548. The combined runtime environment reference value 548 is use as a combined RIM G_H 558.

FIG. 6 illustrates an attestation workflow of a CCE 600 comprising a RIM. The CCE 600 comprises a foundation environment 610, a resource manager 620 (for example a hypervisor). The CCE 600 comprises tenant environment 630 which comprises a workload, libraries and a runtime environment. The CCE 600 comprises a quoting agent 640. The suppler 650 provides modules 652 which are loaded into the tenant environment 630. The supplier 650 further provides a RIMs 654 of its modules which are provided to an attestation verifier 660. The CCE (for example the hypervisor 620) may collect measurements of images of the tenant environment 630 when they are loaded. The measurements are provided to the quoting agent 640 which assembles them for consumption by attestation verifier 660 (for example an Intel® Trust Authority). That is the quoting agent 640 may generate attestation evidence based on these measurements. The attestation evidence is provided to the attestation verifier 660 by the quoting agent 640. The attestation verifier may compare the received RIMS to the attestation evidence to evaluate if a module's integrity has been compromised. If they match the CCE may be considered as untampered and secure. The attestation verifier may provide these attestation results to a requesting party 670.

Further details and aspects are mentioned in connection with the examples described above or below. The examples shown in FIGS. 3 to 6 may include one or more optional additional features corresponding to one or more aspects mentioned in connection with the proposed concept or one or more examples described above (e.g., FIGS. 1-2) or below (e.g., FIGS. 7-9) .

FIG. 7 illustrates a workflow 700 of CCE loading using a vIR. The CCE comprises a tenant environment 710. The tenant environment comprises a workload (WL), a library (lib), a runtime environment (runtime) a bring-up code module (bringup) and a load log. The CCE further comprises a RTMR register 712 and a quoting environment 714. In a first step 730 an installer 720 supplies executable images to the bring-up code. The installer 720 may also create an initial bringup module which is the first module which may also be written to the load log by the installer 720. In a second step 731 the bring-up code measures the runtime environment and records it (for example extended) into a first vIR register vIR0. In a third step 731 the bring-up code measure the library and records it (for example extended) into a second vIR register vIR1. In a fourth step 733 the bring-up code measure the workload and records it (for example extended) into a third vIR register vIRm. In step 734 each of the measured images is loaded into memory of the CCE. Then the vIR values may be stored (for example extended) into the RTMR 712 which further protects the integrity of the vIR registers. In step 735 the entry or the RTMR may be obtained by the quoting environment 714 which may generate a digest D0 of the entry of the RTMR 712 and a signature of S0 the digest. In step 736 the bring-up code may construct a load log containing a history of the loading steps. The integrity of the load log may be protected by the RTMR 712. At step 737 an attestation verifier 740 may request the load log and an attestation evidence based on the digest D0 to evaluate the integrity of the load process. The attestation verifier 740 may use the load log to reconstruct the load sequence and vIR values. A digest of the vIR entries determined by the attestation verifier 740 may be compared to digest D0 in the attestation evidence. If they match, the load log is a correct depiction of loading events. The quote signature S0 authenticates D0.

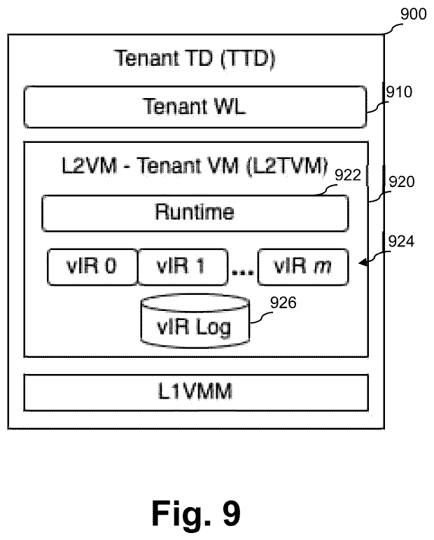

Further details and aspects are mentioned in connection with the examples described above or below. The examples shown in FIG. 7 may include one or more optional additional features corresponding to one or more aspects mentioned in connection with the proposed concept or one or more examples described above (e.g., FIGS. 1-6) or below (e.g., FIG. 8-9).

FIG. 8 illustrates an example of a workload transaction integrity using vIR. A CCE performing the workload transaction comprises a tenant environment 810. The tenant environment 810 comprises a workload 812, a runtime environment 814 and a transaction log 816. The workload 812 cooperates with workload peers 820 to process a stream of transactions. The runtime environment 841 provides a virtual integrity register (vIR) which is limited only by the amount of memory configured for use by the runtime of the CCE. The transaction stream is divided into two batches. The first batch 818 of transactions 0‥m is recorded in the vIR entries vIR0 to vIRm. The second batch 819 of transactions m+1‥m+n is recorded in the vIR entries vIRm+1 to vIRm+n. When the mth transaction is processed, the runtime environment 814 commits the 1st batch to a resettable RTMR 830 ensuring the integrity of the first batch 818 using the hardware integrity register 830. If an attestation occurs at this point in time, the 1st batch of transactions 818 will be reported under the key to the quoting environment. When the 2nd batch of vIRs is completed, if there are no more resettable RTMRs available, the runtime environment 814 may reset the RTMR 830 which may trigger a quote-like integrity register report consisting of the name of the RTMR (e.g., “Tx 0, . . . , m”), the RTMR digest D0, and a signature S0 supplied by a quoting environment (for example QTD). The integrity register report (also referred to as Resettable RTMR Report (RRR)) may be securely archived in the workload transaction log 816. The workload transaction log 816 may not require a secure storage subsystem. The RTMR 830 is zeroized (reset) whereupon the second batch of transactions vIR entries may be integrity protected re-using the same RTMR 830.

This process may be used for other use cases, such as when loading images into the CCE. Multiple integrity register reports may be generated from multiple loadable images, each using a separate vIR maintained by the bring-up loader. After the remainder of the loadable CCE images have been loaded, the resettable RTMR is reset causing a signed integrity register report to be created. In this case, the quoting environment may maintain a log of signed integrity register reports by signaling the quoting environment that the resettable RTMR is being used for system integrity. Once booted, the runtime environment may acquire use of the resettable RTMR for other purposes.

A wide range of use cases may be supported by vIR and resettable RTMRs. This technique may for example be used for system integrity collection and reporting via attestation ecosystems (such as Intel® Trust Authority and Edge/Cloud workload processing).

For example, in the context of system integrity processing, the supply chain may function independently of other suppliers to release software independently, including release of RIM files that may be directly consumed by attestation verifiers. The CCE bring-up loader may be free to load as many images as is required to support a given workload. The series of integrity register reports describing a batch of load operations may be available for output to attestation verifiers upon request as a historical representation of what was loaded. If a workload image may be updated or an additional workload image is added, the vIR and resettable RTMR architecture may be used to capture piecemeal changes to the CCE image post bootstrap.

Further details and aspects are mentioned in connection with the examples described above or below. The examples shown in FIG. 8 may include one or more optional additional features corresponding to one or more aspects mentioned in connection with the proposed concept or one or more examples described above (e.g., FIGS. 1-7) or below (e.g., FIG. 9).

FIG. 9 illustrates the hardening of a vIR using a level 2 virtual machine (L2VM). A tenant environment 900 comprise tenant workload 910. The tenant workload 910 may present a risk to the proper operation of a runtime environment 922 that is controlling vIR resources 924 in that vulnerable workload code could be exploited as a staging ground for deeper exploits affecting operational integrity of the vIRs 924 or vIR log 926. This threat may be reduced by placing a L2VM 920 inside the tenant environment, which is including the runtime environment 922, the vIR resources 924 and the vIR log 926. This VM isolation technology creates an additional barrier that resists deeper exploits. Other CCE technology could be applied as well, such as operating an Intel® SGX enclave within or as a side-car to the Intel® TDX TTD.

Further details and aspects are mentioned in connection with the examples described above. The examples shown in FIG. 9 may include one or more optional additional features corresponding to one or more aspects mentioned in connection with the proposed concept or one or more examples described above (e.g., FIGS. 1-8) .

In the following, some examples of the proposed concept are presented:

An example (e.g., example 1) relates to an apparatus comprising interface circuitry, machine-readable instructions and processing circuitry to execute the machine-readable instructions to record an entry into a virtual integrity register, the entry being based on a measurement of a module, the module being a part of a confidential computing environment, load the module into a memory, the memory being accessible by the confidential computing environment, record an entry of a log, the log comprising a load history, the entry comprising information about the loading of the module, record an entry into an integrity measurement register, the entry being based on the recorded virtual integrity register entry.

Another example (e.g., example 2) relates to a previous example (e.g., example 1) or to any other example, further comprising that the recorded entry in the integrity measurement register is based on a plurality of virtual integrity register entries.

Another example (e.g., example 3) relates to a previous example (e.g., one of the examples 1 to 2) or to any other example, further comprising that the processing circuitry is further to execute the machine-readable instructions to generate a hash tree based on a plurality of entries of the virtual integrity register.

Another example (e.g., example 4) relates to a previous example (e.g., one of the examples 1 to 3) or to any other example, further comprising that the processing circuitry is further to execute the machine-readable instructions to sign one or more entries of the integrity measurement register with a cryptographic key.

Another example (e.g., example 5) relates to a previous example (e.g., one of the examples 1 to 4) or to any other example, further comprising that the processing circuitry is further to execute the machine-readable instructions to transmit an attestation evidence, which is based on one or more recorded entries of the integrity measurement register, and the log to an attestation verifier, the verifier being configured to evaluate the integrity of the module based on attestation evidence and the log.

Another example (e.g., example 6) relates to a previous example (e.g., one of the examples 1 to 5) or to any other example, further comprising that the processing circuitry is further to execute the machine-readable instructions to store an integrity measurement register report based on one or more entries of the integrity measurement register in a memory accessible by the confidential computing environment.

Another example (e.g., example 7) relates to a previous example (e.g., one of the examples 1 to 6) or to any other example, further comprising that the processing circuitry is further to execute the machine-readable instructions to reset the integrity measurement register.

Another example (e.g., example 8) relates to a previous example (e.g., one of the examples 1 to 7) or to any other example, further comprising that the processing circuitry is further to execute the machine-readable instructions to generate the virtual integrity register, wherein virtual integrity register resides in a memory accessible by the confidential computing environment.

Another example (e.g., example 9) relates to a previous example (e.g., one of the examples 1 to 8) or to any other example, further comprising that the module is at least one of a runtime environment, a library and a workload.

Another example (e.g., example 10) relates to a previous example (e.g., one of the examples 1 to 9) or to any other example, further comprising that the module is a workload performing one or more transactions with another party.

Another example (e.g., example 11) relates to a previous example (e.g., one of the examples 1 to 10) or to any other example, further comprising that the measurement of the module is obtained before loading the module into the memory.

Another example (e.g., example 12) relates to a previous example (e.g., one of the examples 1 to 10) or to any other example, further comprising that the measurement of the module is obtained after loading the module into the memory.

Another example (e.g., example 13) relates to a previous example (e.g., one of the examples 1 to 12) or to any other example, further comprising that the processing circuitry is further to execute the machine-readable instructions to generate a digest of the log, and write the digest into the integrity measurement register.

Another example (e.g., example 14) relates to a previous example (e.g., one of the examples 1 to 13) or to any other example, further comprising that the information about the loading of the module comprises at least one of a time step of the loading of the module, a position within a sequence of modules that are loaded and an identifier of the module.

Another example (e.g., example 15) relates to a previous example (e.g., one of the examples 1 to 14) or to any other example, further comprising that the integrity measurement register is a non-volatile memory that is physically separated from other memory and storage accessible by the confidential computing environment.

Another example (e.g., example 16) relates to a previous example (e.g., one of the examples 1 to 15) or to any other example, further comprising that the module is executed in an execution environment of the confidential computing environment.

Another example (e.g., example 17) relates to an edge server, comprising the apparatus according to any one of examples 1 to 15.

An example (e.g., example 18) relates to a method comprising recording an entry into a virtual integrity register, the entry being based on a measurement of a module, the module being a part of a confidential computing environment, loading the module into a memory, the memory being accessible by the confidential computing environment, recording an entry of a log, the log comprising a load history, the entry comprising information about the loading of the module, recording an entry into an integrity measurement register, the entry being based on the recorded virtual integrity register entry.

Another example (e.g., example 19) relates to a previous example (e.g., example 17) or to any other example, further comprising that the recorded entry in the integrity measurement register is based on a plurality of virtual integrity register entries.

Another example (e.g., example 20) relates to a previous example (e.g., one of the examples 18 to 19) or to any other example, further comprising generating a hash tree based on a plurality of entries of the virtual integrity register.

Another example (e.g., example 21) relates to a previous example (e.g., one of the examples 18 to 20) or to any other example, further comprising signing one or more entries of the integrity measurement register with a cryptographic key.

Another example (e.g., example 22) relates to a previous example (e.g., one of the examples 18 to 21) or to any other example, further comprising transmitting an attestation evidence, which is based on one or more recorded entries of the integrity measurement register, and the log to an attestation verifier, the verifier being configured to evaluate the integrity of the module based on attestation evidence and the log.

Another example (e.g., example 23) relates to a previous example (e.g., one of the examples 18 to 22) or to any other example, further comprising storing an integrity measurement register report based on one or more entries of the integrity measurement register in a memory accessible by the confidential computing environment.

Another example (e.g., example 24) relates to a previous example (e.g., one of the examples 18 to 23) or to any other example, further comprising resetting the integrity measurement register.

Another example (e.g., example 25) relates to a previous example (e.g., one of the examples 18 to 24) or to any other example, further comprising generating the virtual integrity register, wherein virtual integrity register resides in a memory accessible by the confidential computing environment.

Another example (e.g., example 26) relates to a previous example (e.g., one of the examples 18 to 25) or to any other example, further comprising that the module is at least one of a runtime environment, a library and a workload.

Another example (e.g., example 27) relates to a previous example (e.g., one of the examples 18 to 26) or to any other example, further comprising that the module is a workload performing one or more transactions with another party.

Another example (e.g., example 28) relates to a previous example (e.g., one of the examples 18 to 27) or to any other example, further comprising that the measurement of the module is obtained before loading the module into the memory.

Another example (e.g., example 29) relates to a previous example (e.g., one of the examples 18 to 27) or to any other example, further comprising that the measurement of the module is obtained after loading the module into the memory.

Another example (e.g., example 30) relates to a previous example (e.g., one of the examples 18 to 29) or to any other example, further comprising generating a digest of the log, and write the digest into the integrity measurement register.

Another example (e.g., example 31) relates to a previous example (e.g., one of the examples 18 to 30) or to any other example, further comprising that the information about the loading of the module comprises at least one of a time step of the loading of the module, a position within a sequence of modules that are loaded and an identifier of the module.

Another example (e.g., example 32) relates to a previous example (e.g., one of the examples 18 to 31) or to any other example, further comprising that the integrity measurement register is a non-volatile memory that is physically separated from other memory and storage accessible by the confidential computing environment.

Another example (e.g., example 33) relates to a previous example (e.g., one of the examples 18 to 32) or to any other example, further comprising that the module is executed in an execution environment of the confidential computing environment.

An example (e.g., example 34) relates to an apparatus comprising processor circuitry configured to record an entry into a virtual integrity register, the entry being based on a measurement of a module, the module being a part of a confidential computing environment, load the module into a memory, the memory being accessible by the confidential computing environment, record an entry of a log, the log comprising a load history, the entry comprising information about the loading of the module, record an entry into an integrity measurement register, the entry being based on the recorded virtual integrity register entry.

An example (e.g., example 35) relates to a device comprising means for processing for recording an entry into a virtual integrity register, the entry being based on a measurement of a module, the module being a part of a confidential computing environment, loading the module into a memory, the memory being accessible by the confidential computing environment, recording an entry of a log, the log comprising a load history, the entry comprising information about the loading of the module, recording an entry into an integrity measurement register, the entry being based on the recorded virtual integrity register entry.

Another example (e.g., example 36) relates to a non-transitory machine-readable storage medium including program code, when executed, to cause a machine to perform the method of any one of examples 18 to 33.

Another example (e.g., example 37) relates to a computer program having a program code for performing the method of any one of examples 18 to 33 when the computer program is executed on a computer, a processor, or a programmable hardware component.

Another example (e.g., example 38) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions and processing circuitry to execute the machine-readable instructions to:
record an entry into a virtual integrity register, the entry being based on a measurement of a module, the module being a part of a confidential computing environment;
load the module into a memory, the memory being accessible by the confidential computing environment;
record an entry of a log, the log comprising a load history, the entry comprising information about the loading of the module;
record an entry into an integrity measurement register, the entry being based on the recorded virtual integrity register entry.

2. The apparatus according to claim 1, wherein the recorded entry in the integrity measurement register is based on a plurality of virtual integrity register entries.

3. The apparatus according to claim 1, wherein the processing circuitry is further to execute the machine-readable instructions to generate a hash tree based on a plurality of entries of the virtual integrity register.

4. The apparatus according to claim 1, wherein the processing circuitry is further to execute the machine-readable instructions to sign one or more entries of the integrity measurement register with a cryptographic key.

5. The apparatus according to claim 1, wherein the processing circuitry is further to execute the machine-readable instructions to transmit an attestation evidence, which is based on one or more recorded entries of the integrity measurement register, and the log to an attestation verifier, the verifier being configured to evaluate the integrity of the module based on attestation evidence and the log.

6. The apparatus according to claim 1, wherein the processing circuitry is further to execute the machine-readable instructions to store an integrity measurement register report based on one or more entries of the integrity measurement register in a memory accessible by the confidential computing environment.

7. The apparatus according to claim 1, wherein the processing circuitry is further to execute the machine-readable instructions to reset the integrity measurement register.

8. The apparatus according to claim 1, wherein the processing circuitry is further to execute the machine-readable instructions to generate the virtual integrity register, wherein virtual integrity register resides in a memory accessible by the confidential computing environment.

9. The apparatus according to claim 1, wherein the module is at least one of a runtime environment, a library and a workload.

10. The apparatus according to claim 1, wherein the module is a workload performing one or more transactions with another party.

11. The apparatus according to claim 1, wherein the measurement of the module is obtained before loading the module into the memory.

12. The apparatus according to claim 1, wherein the measurement of the module is obtained after loading the module into the memory.

13. The apparatus according to claim 1, wherein the processing circuitry is further to execute the machine-readable instructions to generate a digest of the log; and
write the digest into the integrity measurement register.

14. The apparatus according to claim 1, wherein the information about the loading of the module comprises at least one of a time step of the loading of the module, a position within a sequence of modules that are loaded and an identifier of the module.

15. The apparatus according to claim 1, wherein the integrity measurement register is a non-volatile memory that is physically separated from other memory and storage accessible by the confidential computing environment.

16. The apparatus according to claim 1, wherein the module is executed in an execution environment of the confidential computing environment.

17. A method comprising:
recording an entry into a virtual integrity register, the entry being based on a measurement of a module, the module being a part of a confidential computing environment;
loading the module into a memory, the memory being accessible by the confidential computing environment;
recording an entry of a log, the log comprising a load history, the entry comprising information about the loading of the module;
recording an entry into an integrity measurement register, the entry being based on the recorded virtual integrity register entry.

18. The method according to claim 17, wherein the recorded entry in the integrity measurement register is based on a plurality of virtual integrity register entries.

19. The method according to claim 17, further comprising resetting the integrity measurement register.

20. A non-transitory machine-readable storage medium including program code, when executed, to cause a machine to perform the method of claim 17.
